(19) United States
(12) Patent Application Publication
(10) Pub. No.: US 2026/0032189 A1
(43) Pub. Date: Jan. 29, 2026

(54) MOBILE PHONE CASE

(71) Applicant: Shenzhen Sodi Innovation Technologies Co., Ltd, Shenzhen (CN)

(72) Inventors: Yinsheng YE, Shenzhen (CN); Weiping SONG, Shenzhen (CN); Fawen XU, Shenzhen (CN)

(21) Appl. No.: 18/800,236

(22) Filed: Aug. 12, 2024

(30) Foreign Application Priority Data
Jul. 24, 2024 (CN) 202421767371.8

(51) Int. Cl. H04M 1/03; A45C 11/00

(52) U.S. Cl. CPC H04M 1/03; A45C 11/00; A45C 11/002

(57) ABSTRACT

A mobile phone case includes a case body. An accommodating chamber configured to place a mobile phone is provided on the case body. At least one side of the accommodating chamber is a first opening. At least one storage slot configured to store an object is provided on a side wall of the accommodating chamber of the case body. In this way, a user can store a small object, such as a card needle, pills, and an aromatherapy block, through the storage slot, so as to provide a storage space for the user to carry small-sized objects when the user goes out, to solve the problems that a small object is inconvenient to store and easy to lose.

### CROSS-REFERENCE TO RELATED APPLICATIONS

The application claims priority of Chinese patent application CN2024217673718, filed on Jul. 24, 2024, which is incorporated herein by reference in its entireties.

### TECHNICAL FIELD

The present disclosure relates to the technical field of electronic product accessories, and in particular, to a mobile phone case.

### BACKGROUND

As is well known, a mobile phone case is a housing configured to wrap around a mobile phone to prevent the mobile phone from being bumped, scratched, and dropped, thus achieving a protection effect on the mobile phone. However, at present, the existing mobile phone case generally only have a card storage slot on its back surface to place a bank card, a meal card, or the like. A side wall of the existing mobile phone case does not have a storage function, which cannot meet a need of a user.

### SUMMARY

The present disclosure mainly aims to provide a mobile phone case to solve the problem that a side wall of an existing mobile phone case does not have a storage function.

In order to solve the technical problem, the technical scheme provided by the present disclosure is as follows.

A mobile phone case, including a case body, wherein an accommodating chamber configured to place a mobile phone is provided on the case body; at least one side of the accommodating chamber is a first opening; and at least one storage slot configured to store an object is provided on a side wall of the accommodating chamber of the case body.

Further, one side of the storage slot close to the accommodating chamber is a second opening, and the second opening is communicated to the accommodating chamber.

Further, the mobile phone case further includes a cover body; the cover body is detachably arranged at the second opening; the storage slot is formed by cooperation between the cover body and the case body; and the cover body is configured to limit the object inside the storage slot when the cover body is mounted at the second opening.

Further, a side wall of the cover body is recessed to form a first clamping slot; a side wall of the storage slot protrudes to form a first clamping block; and the first clamping block is placed in the first clamping slot when the cover body is mounted at the second opening.

Further, an open slot is provided on one side of the case body close to the accommodating chamber; the open slot is communicated to the storage slot; the cover body is provided with a connecting portion; the connecting portion is placed in the open slot when the cover body is mounted at the second opening; and a length of the open slot is greater than a length of the connecting portion.

Further, there are two storage slots which are arranged at upper and lower parts side by side.

Further, the storage slot includes a card needle slot configured to store a card needle, and a shape of the card needle slot is consistent with a shape of the card needle.

Further, a third opening configured for discharge air is provided on one side of the storage slot away from the first opening.

Further, the storage slot includes an aromatherapy slot configured to store an aromatherapy block.

Further, the case body includes a first rim wrapped around a periphery of the mobile phone and an outer cover; the outer cover includes a second rim arranged on an outer side of the first rim and a back plate connected to the second rim; the accommodating chamber is encircled by the back plate and the first rim;
the storage slot is located on the first rim; the first rim is connected to the second rim to form a buffer space for buffering; the second opening is connected to the buffer space; and the buffer space is annular and is arranged along the outer side of the first rim.

Further, when the storage slot includes an aromatherapy slot, a diffuser hole configured to diffuse the fragrance is provided on the second rim; a third opening configured for discharge air is provided on one side of the storage slot away from the first opening; and the diffuser hole and the third opening are both communicated to the buffer space.

Further, the first rim includes a frame and a storage case; the frame is provided with an embedding port and an embedding slot; the embedding port is located in the embedding slot; the storage slot and the first opening are both located on the storage case; one side of the storage case close to the first opening outwards extends to form a connecting block; the storage case passes through the embedding port; the connection block is arranged in the embedding slot;
several junction structures are arranged between a side wall of the storage case and a side wall of the embedding port; the junction structures include a second clamping block and a second clamping slot; and the second clamping block is arranged in the second clamping slot.

Further, the case body further includes pressing portions used in conjunction with buttons of the mobile phone.

Further, third openings are provided on the second rim; fourth openings are provided on the first rim; and the pressing portions pass through the third openings and the fourth openings.

Further, each pressing portion includes a first limiting block, a connecting section, and a second limiting block; an outer side wall of the second rim is recessed at circumferential sides of the third openings to form first grooves; one side of the first rim close to the accommodating chamber is recessed to form second grooves; the second grooves are located on circumferential sides of the fourth openings; the connecting sections pass through the third openings and the fourth openings; the first limiting blocks are at least partially arranged in the first grooves; the second limiting blocks are arranged in the second grooves; and a depth of each second groove is greater than or equal to a thickness of each second limiting block.

Further, the first rim is provided with fifth openings at positions corresponding to a mobile phone charging interface, a speaker, and a microphone, and the second rim is provided with a sixth opening at a position corresponding to the second opening.

Further, a width of the fifth openings and a width of the sixth opening gradually decrease in a direction close to the accommodating chamber, and the side wall of the sixth opening and the side walls of the fifth openings are smoothly transitioned;
a position, corresponding to the sixth opening, on the second rim is recessed to form a third groove; a width of the third groove is greater than a width of the sixth opening; and an inner side wall of the third groove gradually decreases in the direction close to the accommodating chamber.

Further, a seventh opening is provided at a position, corresponding to a camera of the mobile phone, on the back plate, and a circumferential edge of the back plate at the seventh opening extends towards a back surface to form a protective convex edge.

Further, the back plate is provided with a magnetic suction member configured to be sucked to external equipment.

Further, a fourth groove is provided on one side of the back plate close to the accommodating chamber, and the magnetic suction member is arranged in the fourth groove.

Beneficial effects: Compared with the prior art, in this embodiment, the storage slot configured to store an object is provided on the side wall of the accommodating chamber. In this way, a user can store a small object, such as a card needle, pills, and an aromatherapy block, through the storage slot, so as to provide a storage space for the user to carry small-sized objects when the user goes out, to solve the problems that a small object is inconvenient to store and easy to lose.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a three-dimensional diagram according to the present disclosure;

FIG. 2 is a three-dimensional diagram in another viewing angle according to the present disclosure;

FIG. 3 is an exploded view of the present disclosure;

FIG. 4 is an exploded diagram in another viewing angle according to the present disclosure;

FIG. 5 is an enlarged view of region a in FIG. 4;

FIG. 6 is a structural diagram of a storage case according to the present disclosure;

FIG. 7 is a structural diagram of a storage case in another viewing angle according to the present disclosure;

FIG. 8 is a structural diagram of a cover body according to the present disclosure;

FIG. 9 is a structural diagram of a pressing portion according to the present disclosure;

FIG. 10 is a cross-sectional view along a central axis in a vertical direction according to the present disclosure;

FIG. 11 is an enlarged view of region b in FIG. 10;

FIG. 12 is a cross-sectional view of a pressing portion in a transverse direction according to the present disclosure; and

FIG. 13 is an enlarged view of region c in FIG. 11.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

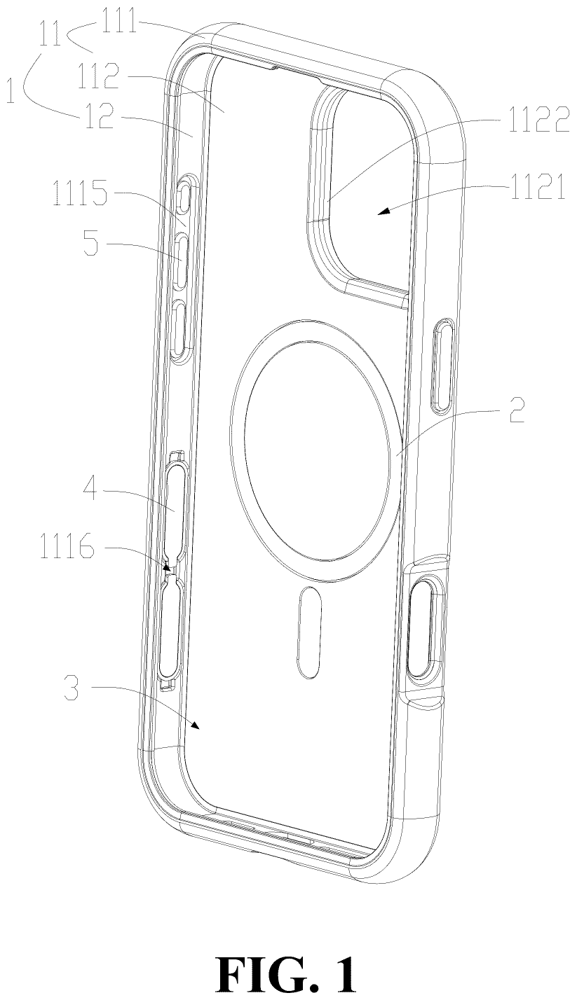

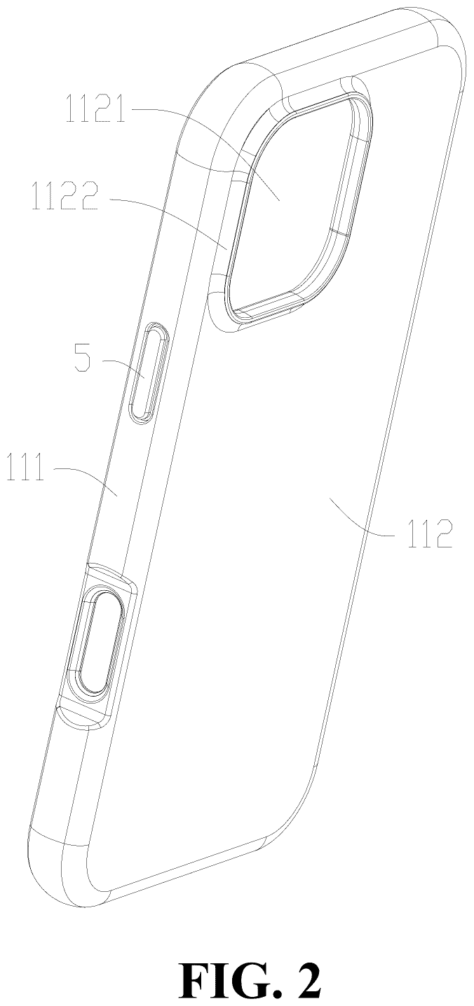

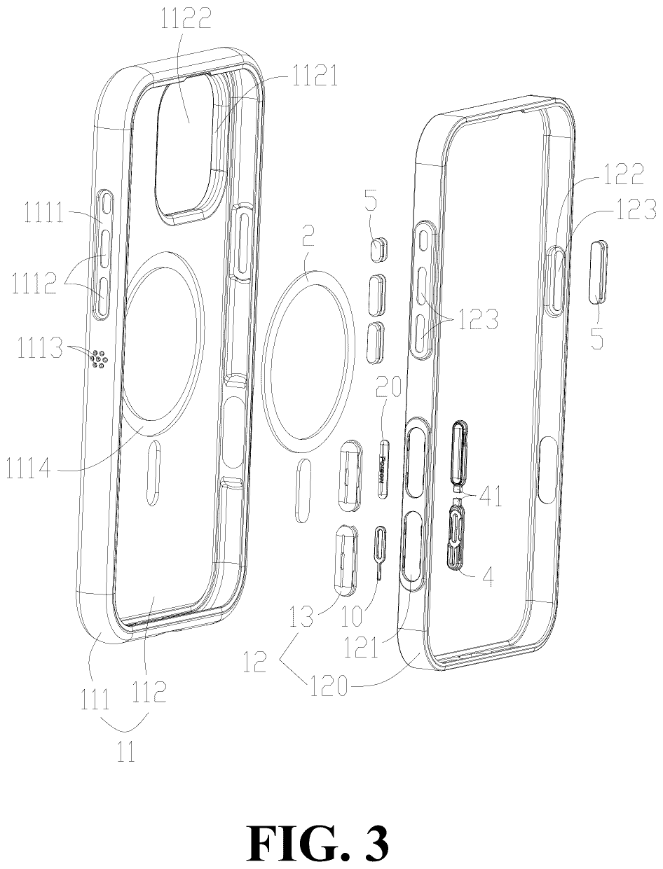

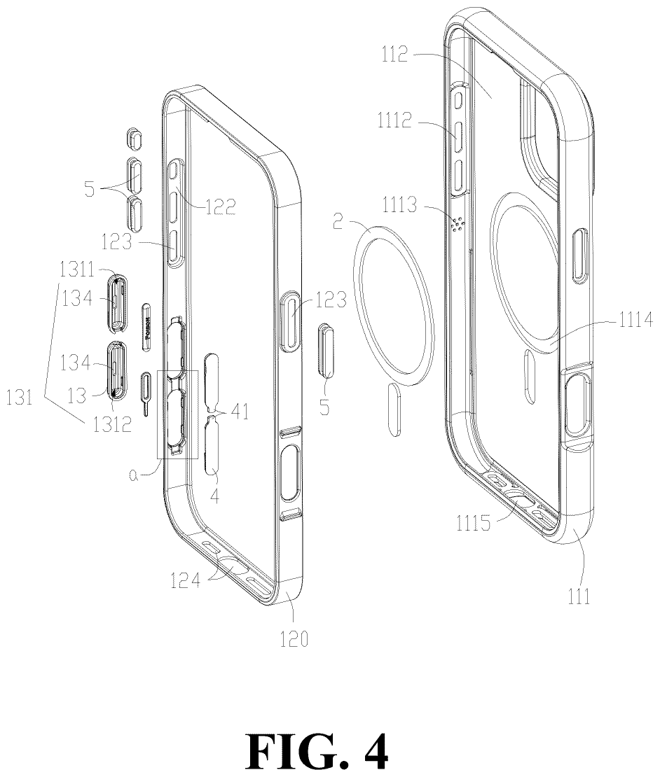

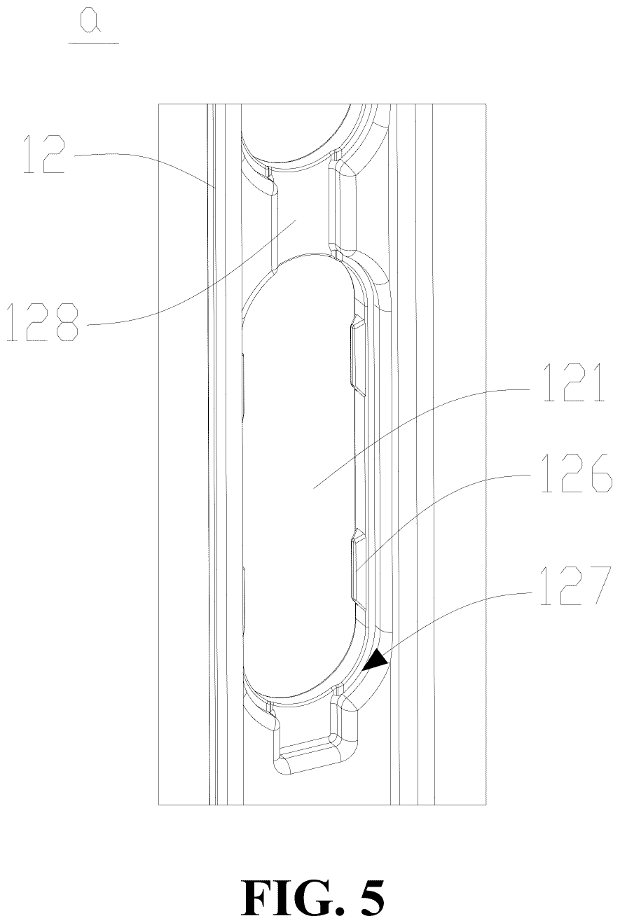

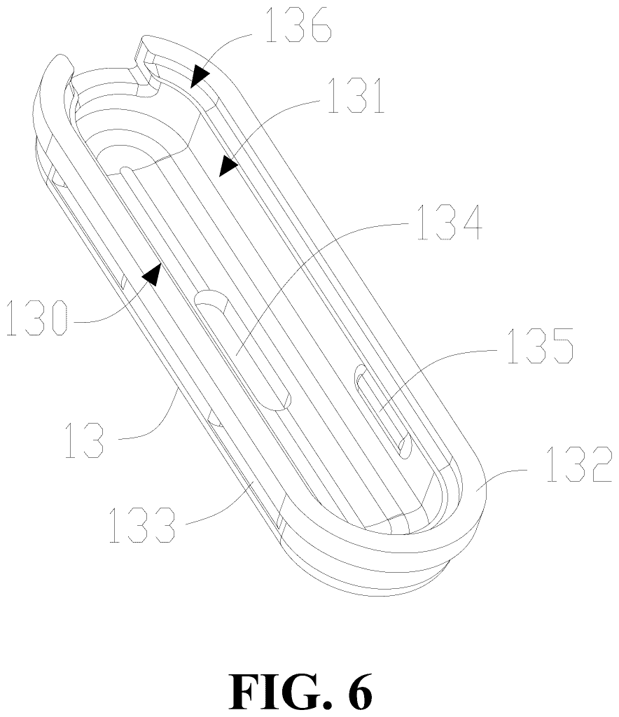

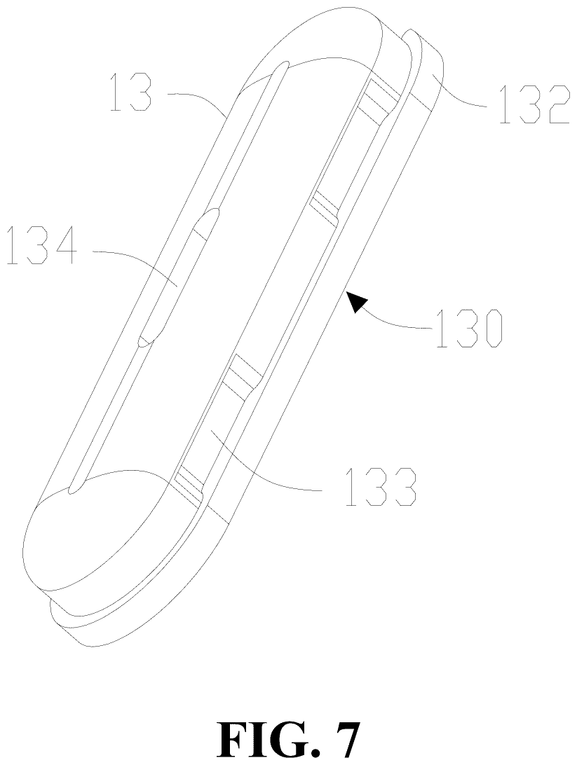

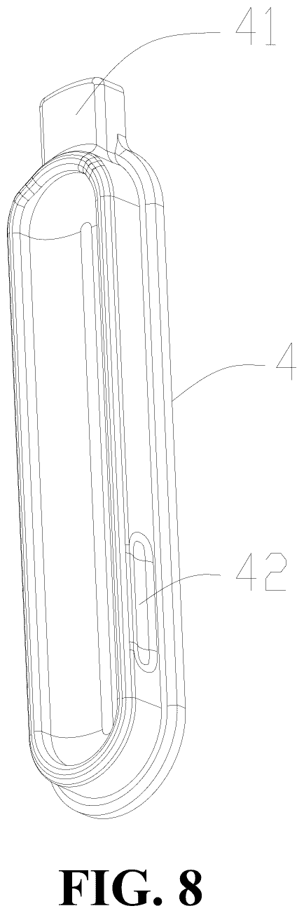

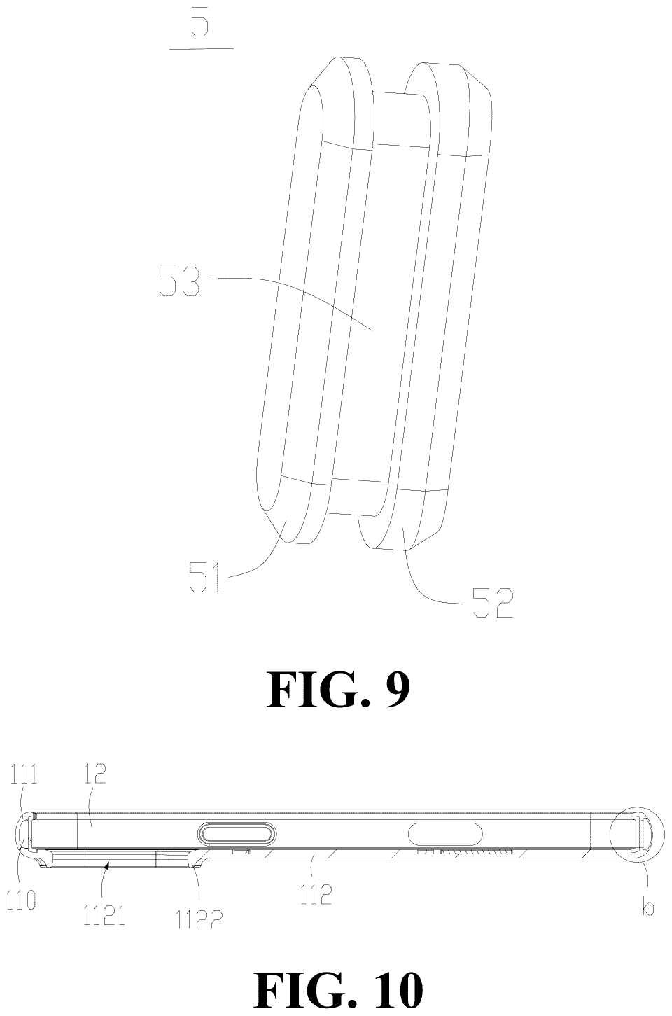

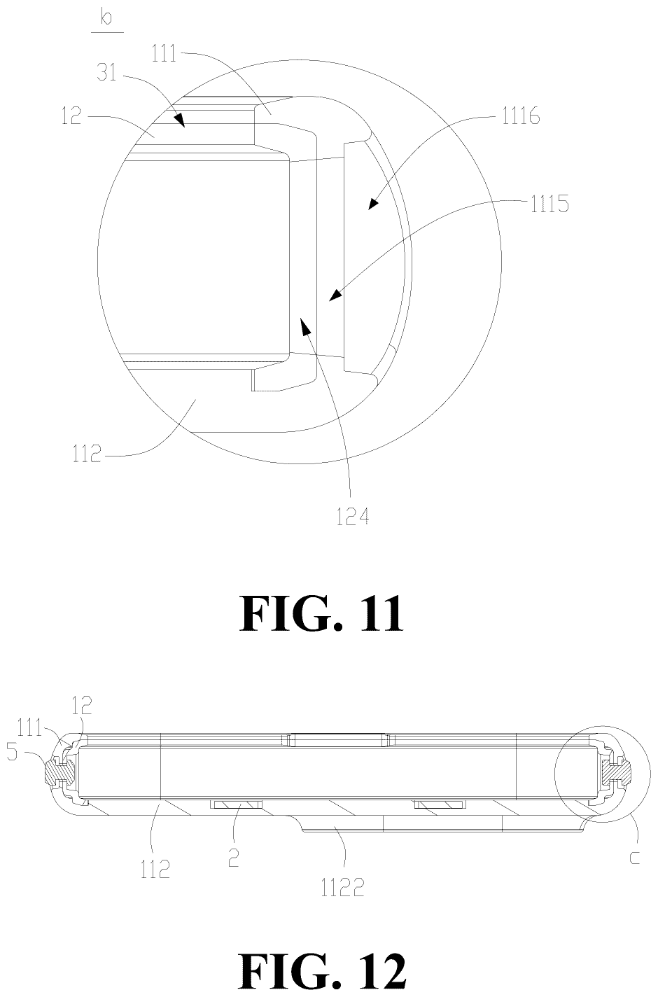

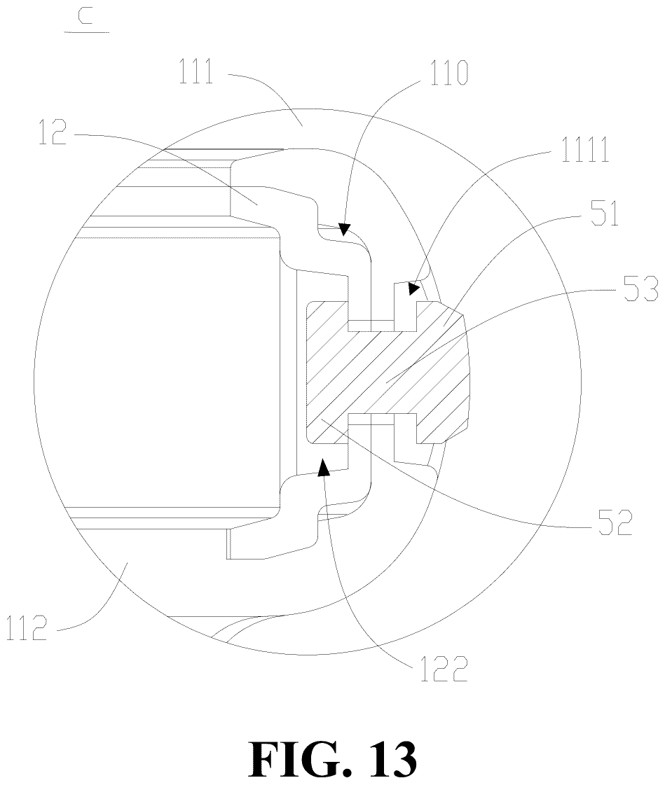

Referring to FIG. 1 to FIG. 13, a mobile phone case in the embodiments of the present disclosure is shown.

The mobile phone case includes a case body 1; an accommodating chamber 3 configured to place a mobile phone is provided on the case body 1; at least one side of the accommodating chamber 3 is a first opening 31; and at least one storage slot 131 configured to store an object is provided on a side wall of the accommodating chamber 3 of the case body 1.

In this embodiment, the mobile phone can be protected when the mobile phone is placed in the accommodating chamber 3. In this embodiment, the storage slot 131 configured to store an object is provided on the side wall of the accommodating chamber 3. In this way, a user can store a small object, such as a card needle, pills, and an aromatherapy block, through the storage slot 131, so as to provide a storage space for the user to carry small-sized objects when the user goes out, to solve the problems that a small object is inconvenient to store and easy to lose.

In an embodiment, one side of the storage slot 131 close to the accommodating chamber 3 is a second opening 130, and the second opening 130 is communicated to the accommodating chamber 3. Namely, when storing a small object, a user needs to: place the object in the accommodating chamber 3 when the mobile phone is not placed in the accommodating chamber 3, and then place the mobile phone in the accommodating chamber 3. The mobile phone can be used to limit the object and prevent the object from falling off.

In an embodiment, the mobile phone case further includes a cover body 4; the cover body 4 is detachably arranged at the second opening 130; the storage slot 131 is formed by cooperation between the cover body 4 and the case body 1; and the cover body 4 is configured to limit the object inside the storage slot 131 when the cover body 4 is mounted at the second opening 130, so that the object is not in contact with the mobile phone.

In an embodiment, a side wall of the cover body 4 is recessed to form a first clamping slot 42; a side wall of the storage slot 131 protrudes to form a first clamping block 135; and the first clamping block 135 is placed in the first clamping slot 42 when the cover body 4 is mounted at the second opening 130, to achieve detachable connection between the cover body 4 and the second opening 130. Specifically, a material of the cover body 4 is soft rubber, and a material of the case body 1 is either a hard material or soft rubber; or, when the material of the case body 1 is the soft rubber, the material of the cover body 4 can be a hard material. In other embodiments, the first clamping slot 42 may be further located on the side wall of the storage slot 131, and the first clamping block 135 may be located on the cover body 4, to achieve buckling and achieve the detachable connection between the cover body 4 and the second opening 130.

In other embodiments, the second opening 130 can be further provided on one side away from the accommodating chamber 3, and a cover body 4 can be configured for the storage slot 131, to achieve a function of limiting the object and prevent the object from falling off.

In one embodiment, an open slot 128 is provided on one side of the case body 1 close to the accommodating chamber 3; the open slot 128 is communicated to the storage slot 131; the cover body 4 is provided with a connecting portion 41; the connecting portion 41 is placed in the open slot 128 when the cover body 4 is mounted at the second opening 31; and a length of the open slot 128 is greater than a length of the connecting portion 41. In this way, when the cover body 4 is mounted at the first opening 31, a portion of the opening slot 128 will be reserved. When a user needs to take out the object in the storage slot 131, the reserved opening slot 128 can be used to facilitate the user to: touch the connecting portion 41, drive the cover body 4 using the connecting portion 41, and remove the cover body 4, so that it is convenient for the user to take the object.

In the above embodiment, there may be one or more storage slots 131. The plurality of storage slots 131 may be located on two sides or one side of the accommodating chamber 3, or the plurality of storage slots 131 can be further located on two adjacent side walls of the accommodating chamber 3.

In an embodiment, there may be two storage slots 131 which are arranged at upper and lower parts side by side.

In one embodiment, the storage slot 131 includes a card needle slot 1312 configured to store a card needle 10, and a shape of the card needle slot 1312 is consistent with a shape of the card needle 10. During storage of the card needle 10, the card needle 10 will not shake, and the structure is compact.

In an embodiment, a third opening 1112 configured to discharge air is provided on one side of the storage slot 131 away from the first opening 31, so that when the cover body 4 is mounted at the first opening 31, air inside can be discharged from the air outlet hole 134, so that it is convenient to cover the second opening 130 with the cover body 4.

In an embodiment, the storage slot 131 includes an aromatherapy slot 1311 configured to store an aromatherapy block 20, and the fragrance of the aromatherapy block 20 can be diffused to the outside through the air outlet hole 134. In addition, when the aromatherapy block 20 contains a mosquito repellent substance, a role in repelling mosquitoes can be further achieved by diffusion of the fragrance. Specifically, when the aromatherapy block 20 is shaped like a capsule, the aromatherapy slot 1311 is shaped like a capsule too.

In an embodiment, the case body 1 includes a first rim 12 wrapped around a periphery of the mobile phone and an outer cover 11; the outer cover 11 includes a second rim 111 arranged on an outer side of the first rim 12 and a back plate 112 connected to the second rim 111; the accommodating chamber 3 is encircled by the back plate 112 and the first rim 12; the storage slot 131 is located on the first rim 12; the first rim 12 is connected to the second rim 111 to form a buffer space 110 for buffering; the second opening 130 is connected to the buffer space 110; and the buffer space 110 is annular and is arranged along the outer side of the first rim 12. By use of the buffer space 110, when the material of the outer cover 11 is the soft rubber, the case body 1 can be formed into an air bag. When the mobile phone is collided, a buffer effect is achieved, thereby protecting the mobile phone.

Specifically, both the outer cover 11 and the first rim 12 can be made of a transparent, semi-transparent, or opaque material.

In an embodiment, when the storage slot 131 includes an aromatherapy slot 1311, a diffuser hole 1113 configured to diffuse the fragrance is provided on the second rim 111; an air outlet hole 134 configured to discharge air is provided on one side of the storage slot 131 away from the first opening 31; and the diffuser hole 1113 and the air outlet hole 134 are both communicated to the buffer space 110. In this way, the fragrance of the aromatherapy block 20 can be diffused into the air through the air outlet hole 134, the buffer space 110, and the diffuser hole 1113.

In an embodiment, the first rim 12 includes a frame 120 and a storage case 13; the frame 120 is provided with an embedding port 121 and an embedding slot 127; the embedding port 121 is located in the embedding slot 127; the storage slot 131 and the first opening 31 are both located on the storage case 13; one side of the storage case 13 close to the first opening 31 outwards extends to form a connecting block 132; the storage case 13 passes through the embedding port 121; the connection block 132 is arranged in the embedding slot 127; several junction structures are arranged between a side wall of the storage case 13 and a side wall of the embedding port 121; the junction structures include a second clamping block 126 and a second clamping slot 133; and the second clamping block 126 is arranged in the second clamping slot 133 to achieve stable connection between the storage case 13 and the frame 120. Specifically, both the outer cover 11 and the first rim 12 can be made of a transparent, semi-transparent, or opaque material. The storage case 13 can be connected to the frame 120 by a buckle, or the storage case 13 can be connected to the frame 120 by secondary injection molding. In other embodiments, the frame 120 and the storage case 13 can be further integrally formed.

In the above embodiment, the case body 1 further includes pressing portions 5 used in conjunction with buttons of the mobile phone, so that when a user presses each pressing portion 5, the user can press a button on the mobile phone, which facilitates use by the user.

Specifically, the pressing portions 5 can be integrally formed with the frame 120 or the first rim 12, or the pressing portions 5 can be an independent part connected to the frame 120 and/or the first rim 12 in a way such as pasting or buckling.

In an embodiment, third openings 1112 are provided on the second rim 111; fourth openings 123 are provided on the first rim 12; and the pressing portions 5 pass through the third openings 1112 and the fourth openings 123. When the pressing portions 5 are pressed, the pressing portions 5 can be in contact with the buttons of the mobile phone.

In an embodiment, to make the structure of this embodiment compact, each pressing portion 5 includes a first limiting block 51, a connecting section 53, and a second limiting block 52; an outer side wall of the second rim 111 is recessed at circumferential sides of the third openings 1112 to form first grooves 1111; one side of the first rim 12 close to the accommodating chamber 3 is recessed to form second grooves 122; the second grooves 122 are located on circumferential sides of the fourth openings 123; the connecting sections 53 pass through the third openings 1112 and the fourth openings 123; the first limiting blocks 51 are at least partially arranged in the first grooves 1111; and the second limiting blocks 52 are arranged in the second grooves 122, to achieve the mounting of the pressing portions 5. A depth of each second groove 122 is greater than or equal to a thickness of each second limiting block 52, which can prevent the pressing portions 5 from protruding.

In an embodiment, the first rim 12 is provided with fifth openings 124 at positions corresponding to a mobile phone charging interface, a speaker, and a microphone, and the second rim 111 is provided with a sixth opening 1115 at a position corresponding to the second opening 130, so that it is convenient for a user to charge the mobile phone and it is convenient to transmit the sound of the speaker.

In an embodiment, to facilitate a user to connect the mobile phone to the charging interface and facilitate sound transmission, side walls of the fifth openings 124 and a side wall of the sixth opening 1115 gradually decrease in a direction close to the accommodating chamber 3, and the side wall of the sixth opening 1115 and the side walls of the fifth openings 124 are smoothly transitioned; a position, corresponding to the sixth opening 1115, on the second rim 111 is recessed to form a third groove 1116; a width of the third groove 1116 is greater than a width of the sixth opening 1115; and an inner side wall of the third groove 1116 gradually decreases in the direction close to the accommodating chamber 3.

In an embodiment, a seventh opening 1121 is provided at a position, corresponding to a camera of the mobile phone, on the back plate 112, and a circumferential edge of the back plate 112 at the seventh opening 1121 extends towards a back surface to form a protective convex edge 1122. When the mobile phone is placed in the accommodating chamber 3, the protective convex edge 1122 is located at a circumferential edge of the camera and slightly protrudes out of the camera, so that when the mobile phone drops, the camera will not be in direct contact with the ground, thereby playing a role in protecting the camera.

In an embodiment, the back plate 112 is provided with a magnetic suction member 2 configured to be sucked to external equipment, so that when a user uses the mobile phone case of this embodiment, the mobile phone can be sucked onto external equipment such as a wireless charging support or a mobile phone holder through the magnetic suction member 2 for use with the external equipment. Specifically, the magnetic suction member 2 can be an iron sheet, a magnet, or the like.

In an embodiment, a fourth groove 1114 is provided on one side of the back plate 112 close to the accommodating chamber 3, and the magnetic suction member 2 is arranged in the fourth groove 1114, so as to beautify the appearance of the mobile phone case of this embodiment. Specifically, the magnetic suction member 2 can be connected to the back plate 112 through injection molding, pasting, and the like. Of course, in other embodiments, the magnetic suction member 2 can be further arranged on one side of the back plate 112 away from the accommodating chamber 3.

It should be noted that all directional indications (such as up, down, left, right, front, back . . . ) in the embodiments of the present disclosure are only used to explain a relative positional relationship between components, motion situations, etc. at a certain specific attitude (as shown in the figures). If the specific attitude changes, the directional indication also correspondingly changes.

In addition, the descriptions of “first”, “second”, etc. in the present disclosure are only used for descriptive purposes, and cannot be understood as indicating or implying its relative importance or implicitly indicating the number of technical features indicated. Therefore, features defined by “first” and “second” can explicitly instruct or impliedly include at least one feature. In addition, “and/or” in the entire text includes three solutions. A and/or B is taken as an example, including technical solution A, technical solution B, and technical solutions that both A and B satisfy. In addition, the technical solutions between the various embodiments can be combined with each other, but it needs be based on what can be achieved by those of ordinary skill in the art. When the combination of the technical solutions is contradictory or cannot be achieved, it should be considered that such a combination of the technical solutions does not exist, and is not within the scope of protection claimed by the present disclosure.

The above descriptions are only preferred embodiments of the present disclosure, and are not intended to limit the patent scope of the present disclosure. Any equivalent structural transformation made by using the content of the specification and the drawings of the present disclosure under the invention idea of the present disclosure, directly or indirectly applied to other related technical fields, shall all be included in the scope of patent protection of the present disclosure.

What is claimed is:

1. A mobile phone case, comprising a case body, wherein an accommodating chamber configured to place a mobile phone is provided on the case body; at least one side of the accommodating chamber is a first opening; and at least one storage slot configured to store an object is provided on a side wall of the accommodating chamber of the case body.

2. The mobile phone case according to claim 1, wherein one side of the storage slot close to the accommodating chamber is a second opening, and the second opening is communicated to the accommodating chamber.

3. The mobile phone case according to claim 2, wherein the mobile phone case further comprises a cover body; the cover body is detachably arranged at the second opening; the storage slot is formed by cooperation between the cover body and the case body; and the cover body is configured to limit the object inside the storage slot when the cover body is mounted at the second opening.

4. The mobile phone case according to claim 3, wherein a side wall of the cover body is recessed to form a first clamping slot; a side wall of the storage slot protrudes to form a first clamping block; and the first clamping block is placed in the first clamping slot when the cover body is mounted at the second opening.

5. The mobile phone case according to claim 3, wherein an open slot is provided on one side of the case body close to the accommodating chamber; the open slot is communicated to the storage slot; the cover body is provided with a connecting portion; the connecting portion is placed in the open slot when the cover body is mounted at the second opening; and a length of the open slot is greater than a length of the connecting portion.

6. The mobile phone case according to claim 3, wherein there are two storage slots which are arranged at upper and lower parts side by side.

7. The mobile phone case according to claim 3, wherein the storage slot comprises a card needle slot configured to store a card needle, and a shape of the card needle slot is consistent with a shape of the card needle.

8. The mobile phone case according to claim 2, wherein a third opening configured for discharge air is provided on one side of the storage slot away from the first opening.

9. The mobile phone case according to claim 8, wherein the storage slot comprises an aromatherapy slot configured to store an aromatherapy block.

10. The mobile phone case according to claim 2, wherein the case body comprises a first rim wrapped around a periphery of the mobile phone and an outer cover; the outer cover comprises a second rim arranged on an outer side of the first rim and a back plate connected to the second rim; the accommodating chamber is encircled by the back plate and the first rim;
the storage slot is located on the first rim; the first rim is connected to the second rim to form a buffer space for buffering; the second opening is connected to the buffer space; and the buffer space is annular and is arranged along the outer side of the first rim.

11. The mobile phone case according to claim 10, wherein when the storage slot comprises an aromatherapy slot, a diffuser hole configured to diffuse the fragrance is provided on the second rim; a third opening configured for discharge air is provided on one side of the storage slot away from the first opening; and the diffuser hole and the third opening are both communicated to the buffer space.

12. The mobile phone case according to claim 10, wherein the first rim comprises a frame and a storage case; the frame is provided with an embedding port and an embedding slot; the embedding port is located in the embedding slot; the storage slot and the first opening are both located on the storage case; one side of the storage case close to the first opening outwards extends to form a connecting block; the storage case passes through the embedding port; the connection block is arranged in the embedding slot;
several junction structures are arranged between a side wall of the storage case and a side wall of the embedding port; the junction structures comprise a second clamping block and a second clamping slot; and the second clamping block is arranged in the second clamping slot.

13. The mobile phone case according to claim 10, wherein the case body further comprises pressing portions used in conjunction with buttons of the mobile phone.

14. The mobile phone case according to claim 13, wherein third openings are provided on the second rim; fourth openings are provided on the first rim; and the pressing portions pass through the third openings and the fourth openings.

15. The mobile phone case according to claim 14, wherein each pressing portion comprises a first limiting block, a connecting section, and a second limiting block; an outer side wall of the second rim is recessed at circumferential sides of the third openings to form first grooves; one side of the first rim close to the accommodating chamber is recessed to form second grooves; the second grooves are located on circumferential sides of the fourth openings; the connecting sections pass through the third openings and the fourth openings; the first limiting blocks are at least partially arranged in the first grooves; the second limiting blocks are arranged in the second grooves; and a depth of each second groove is greater than or equal to a thickness of each second limiting block.

16. The mobile phone case according to claim 10, wherein the first rim is provided with fifth openings at positions corresponding to a mobile phone charging interface, a speaker, and a microphone, and the second rim is provided with a sixth opening at a position corresponding to the second opening.

17. The mobile phone case according to claim 16, wherein a width of the fifth openings and a width of the sixth opening gradually decrease in a direction close to the accommodating chamber, and the side wall of the sixth opening and the side walls of the fifth openings are smoothly transitioned;
a position, corresponding to the sixth opening, on the second rim is recessed to form a third groove; a width of the third groove is greater than a width of the sixth opening; and an inner side wall of the third groove gradually decreases in the direction close to the accommodating chamber.

18. The mobile phone case according to claim 10, wherein a seventh opening is provided at a position, corresponding to a camera of the mobile phone, on the back plate, and a circumferential edge of the back plate at the seventh opening extends towards a back surface to form a protective convex edge.

19. The mobile phone case according to claim 10, wherein the back plate is provided with a magnetic suction member configured to be sucked to external equipment.

20. The mobile phone case according to claim 19, wherein a fourth groove is provided on one side of the back plate close to the accommodating chamber, and the magnetic suction member is arranged in the fourth groove.
